(19) United States
(12) Patent Application Publication
(10) Pub. No.: US 2018/0124082 A1
(43) Pub. Date: May 3, 2018

(54) CLASSIFYING LOGINS, FOR EXAMPLE AS BENIGN OR MALICIOUS LOGINS, IN PRIVATE NETWORKS SUCH AS ENTERPRISE NETWORKS FOR EXAMPLE

(71) Applicant: New York University, New York, NY (US)

(72) Inventors: Seyedhossein Siadati, New York, NY (US); Nasir MEMON, Brooklyn, NY (US)

(21) Appl. No.: 15/789,951

(22) Filed: Oct. 20, 2017

Related U.S. Application Data
(60) Provisional application No. 62/410,772, filed on Oct. 20, 2016.

(51) Int. Cl. H04L 29/06; G06N 99/00; G06N 5/04

(52) U.S. Cl. CPC H04L 63/1425; G06N 5/047; G06N 99/005

(57) ABSTRACT

Logins within a private network are classified as benign or malicious by (a) receiving login patterns within a private network, wherein each login pattern includes one or more attributes of each of (i) a user uniquely associated with the login, (ii) a source computer uniquely associated with the login, and (iii) a destination computer uniquely associated with the login, and wherein each login pattern is characterized as one of (A) a normal login pattern, (B) a benign login pattern, or (C) a malicious login pattern; (b) receiving a new login; and (c) classifying the new login as benign or malicious using the login patterns for the private network that were received.

### § 1. RELATED APPLICATIONS

This application claims the benefit of U.S. Provisional Patent Application Ser. No. 62/410,772 (incorporated herein by reference and referred to as “the '772 provisional”), filed on Oct. 20, 2017, titled “DETECTING MALICIOUS LOGINS BASED ON ACCESS CHARACTERISTICS” and listing Hossein Siadati and Nasir Memon as the inventors. The present invention is not limited to requirements of the particular embodiments described in the '772 provisional application.

### § 2. BACKGROUND OF THE INVENTION

### § 2.1 Field of the Invention

The present invention concerns private networks, such as enterprise networks for example. More specifically, the present invention concerns systems and methods for detecting malicious logins in private networks, such as malicious logins used in credential-based lateral movement (“CLM”) attacks.

### § 2.2 Background Information

Enterprise networks have been frequent targets of data breaches and sabotage. Advanced Persistent Threats (“APT”) are targeted cyber attacks against organizations and companies. Most resources that are of value to attackers are not directly exposed to an external network. It is rather a lengthy journey to try different approaches persistently in a long span of time (from few months to a few years) to get access to such resources.

The security community has recognized that credential stealing is the most frequently used technique in APT attacks. Although many companies have security monitoring tools including anti-malware, Firewall, and Intrusion Detection Systems (“IDS”), attackers are often able to bypass these tools using stolen credentials to complete their missions. Therefore, credential stealing has become the favorite method of attackers.

Almost any collaboration between hosts in a network (e.g., file sharing, screen sharing, application access) requires user authentication. Windows networks mostly use NTLM (See, e.g., Microsoft. Microsoft NTLM. https://msdn.microsoft.com/enus/library/windows/desktop/aa378749(v=vs.85).aspx. [Online; accessed 18 Jul. 2016] (incorporated herein by reference.) and Kerberos (MIT. Kerberos: The network authentication protocol. http://web.mit.edu/kerberos/. [Online; accessed 18 Jul. 2016] (incorporated herein by reference).) to authenticate the users and processes. A process in the client machine starts the authentication procedure by providing a user-entered password to the authenticator process in the destination machine (or to the Key Distribution Center (“KDC”) in the Kerberos protocol). After the first successful authentication, and in order to avoid requesting the password from users again, the client machine will receive a token (e.g., the cryptographic hash, Tickets) to use for further communications.

Credential stealing is easier than it is perceived. The most desired type of credentials that the attackers look for is plaintext passwords because (1) they expire or update infrequently, (2) they are re-used by users for multiple accounts, and (3) they can be used by attackers to guess other passwords. Attackers may try one of a few methods to find the plain text passwords:
Phishing. Attackers frequently use social engineering techniques to steal the passwords. In a variation of phishing attacks, users are tricked to enter their password into a malicious website masquerading as a legitimate one.
Online Password Guessing. Attackers may brute-force frequently used passwords over one computer (vertically) or several computers (horizontally). They will be able to takeover accounts with weak passwords. Conficker worm used an online dictionary attack on administrator passwords to compromise millions of machines.
Offline Password Guessing. By accessing the hash of the passwords, the attackers then use hash-cracking methods to find the plain text password. Attackers get access to the hash of the passwords using different methods including running a rogue service (e.g., Domain Controller) to get other computers to send authentication requests including hashes of the passwords. Password cracking has become incredibly fast.
Password Dumping. By accessing the memory of the compromised computers using tools such as Mimikatz, attackers can read the plain text password after user enters them into the computer. This method can capture the password of the user who uses Windows remote interactive login (i.e., Remote Desktop) to access the infected computer. This is one of the main methods to capture more important credentials. Keylogger Malware is another means of capturing plain text credentials whenever an attached keyboard is used for password entry.

If the attackers fail to gain access to plaintext password, they can still authenticate themselves on the destination computer using pass-the-hash method. (See, e.g., Wikipedia. Pass the hash. https://en.wikipedia.org/wiki/Pass_the_hash. [Online; accessed 18 Jul. 2016] (incorporated herein by reference).) This method exploits the fact that authentications in the network are often done using the tokens delivered to the client after initial authentication. These tokens, in the form of Hash (in NTLM protocol) or Ticket (in Kerberos), can be reused by attackers to connect to destination computer. In the case of Kerberos, one type of Ticket (i.e., Ticket Granting Ticket) can be used to issue other forms of Tickets usable to login to destination computers. Pass-the-hash method is not always persistent because the hash/tickets expires after a defined period of time (in the order of hours).

A common theme of these attacks is to follow a step-by-step process of chained computer hacking to reach a planned target computer. In these attacks, the attacker steals and uses valid credentials to compromise the next computer in the chain. Such an attacker begins by setting up a foothold in a network by compromising one computer, often by spear phishing. The attacker then steals passwords of network users and uses them to log in to other computers. Doing this, the attacker moves “laterally” between computers until obtaining access to critical data located deeper inside the network. That is, once they gain a foothold in the private network, the attacker then typically escalates privileges, pivots the attack towards other computers, and moves between them to find so-called “crown jewels” (the most valuable assets) located deeper inside the private network. The movements between computers and the escalation of privileges are referred to as lateral movement. This method of attack is referred to as Credential-based Lateral Movement (“CLM”) in this application. Attackers have used this technique in many instances of data breaches.

Using valid credentials to move laterally across the network is stealthy (cannot be detected by anti-malware and IDS), persistent (credentials can be used to come back to network anytime even after clean-ups by anti-malware), and scalable (multiple computers can be accessed by stealing a single credential) in comparison with exploiting vulnerabilities of the computers.

Traditional network intrusion detection systems (“NIDS”) detect malicious network traffic that signifies execution of a remote exploit. Since the content of network traffic in CLM is indistinguishable from a benign login, NIDS is not useful in the detection of CLM. On the other hand, access control policies and tools (e.g., Access Control Lists, Active Directory) fail to minimize the possible paths of lateral movement, due to obstacles faced in an enterprise environment in achieving a perfect implementation of the principle of least privilege. (See, e.g., the article Jerome H Saltzer, “Protection and the Control of Information Sharing,” Multics. Commun., ACM 17, 7, pp. 388-402 (1974) (incorporated herein by reference).) Access control is usually relaxed to facilitate business continuity and to enable recovery of computer services when they fail. Therefore, permissions are provisioned for the worst case scenarios, allowing logins that would not usually be required. Sinclair et al. (Sara Sinclair, Sean W Smith, Stephanie Trudeau, M Eric Johnson, and Anthony Portera, “Information Risk in Financial Institutions: Field Study and Research Roadmap,” International Workshop on Enterprise Applications and Services in the Finance Industry, pp. 165-180 (Springer, 2007) (incorporated herein by reference)) have studied the problem of access controls in enterprise networks and showed that 50-90% of users are over-entitled regarding what they can access. This situation allows attackers to use stolen credentials to roam easily within a network and capture their target destinations. Consequently, many traditional network security tools can not detect CLM attacks. Methods used for classification of malicious logins to websites, such as those discussed in the article, D. M. Freeman, S. Jain, M. Dürmuth, B. Biggio, and G. Giacinto, “Who are you? A Statistical Approach to Measuring User Authenticity,” NDSS, The Internet Society, 2016 (incorporated by reference) for example, can not address the problem of credential based lateral movements effectively. This is mainly due to the large variation among types of accounts and roles of computers, assignment of multiple accounts to individuals, activities of several accounts on one computer, and network and business dynamics that make login events inside enterprise networks more complex and variable than user (mainly customer) logins to online services.

Credentials are prone to guessing/stealing and therefore are not sufficient for authentication of critical operations (e.g., password rest). Freeman et al., cited above, have demonstrated the effectiveness of using a supervised statistical method for implicit authentication (i.e., reinforced authentication) using different features, including IP address, geolocation, operating system and browser configuration, and the account's patterns of usage. The main intuition is that users usually use certain IP addresses and computers to connect to a websites. As a result, probability of a malicious login can be computed based on observed features. Similar methods are used by online service providers for user authentication. Unfortunately, however, these approaches are not appropriate for CLM. Again, dynamics of the network configuration, computer roles, and user role and duties make the login behaviors in private networks such as enterprise networks more variable than an end user's (consumers) login to online services. Secondly, each pair of computers in an enterprise network can authenticate to one other and needs to be validated. In comparison, only logins to servers are validated in online services. Finally, labeled data is not available for supervised learning in this work.

Shi et al. (E. Shi, Y. Niu, M. Jakobsson, and R. Chow, “Implicit Authentication Through Learning User Behavior,” International Conference on Information Security, pp. 99-113 (Springer, 2010) (incorporated herein by reference)) have proposed a method for mobile authenticating by computing an authentication score based on a user's activities. The score is boosted upon observing consistent behaviors (e.g., buying coffee in the same store) and is lowered upon observing inconsistent (e.g., calling an unknown number) or suspicious behaviors (e.g., events commonly associated with abuse or device theft). The method in the Shi paper is limited to the cases where the device is stolen by an attacker and an aggregation of suspicious behaviors is observed. In comparison, in a CLM attack, the account is used by normal user and the attacker at the same time, and therefore will not be detectable by the approach in the Shi paper.

Having a good perception of the network events is crucial for security analysts to identify security problems. Network data visualization has been used to provide a graphical display of network events. Network data comes from different sources including Firewalls, IDS, DNS, and proxies. Other source of network data includes logs generated on workstations and servers, including anti-malware alerts, processes, registries, and Windows login events. However, computer networks are very active, and the volume of log data generated based on the host and network activities is huge. The volume and variety of data (often referred to as being “hairballs”) as well as the complexity of the relation between events in the network make it challenging to present these data in their original text format or tabular format. (See, e.g., C. C. Gray, P. D. Ritsos, and J. C. Roberts, Contextual Network Navigation; Situational Awareness for Network Administrators (incorporated herein by reference).) Therefore, different visualization techniques are being proposed and used for the purpose of attack detection and forensics.

Abdullah et al. (K. Abdullah, C. Lee, G. Conti, and J. A. Copeland, “Visualizing Network Data for Intrusion Detection,” IAW, pp. 100-108 (IEEE, 2005) (incorporated herein by reference)) have proposed a histogram-based visualization technique that visualizes the summary of requests to/from different ports. The X-axis shows the time and Y-axis shows stacked size of packets sent to each port. This visualization helps to detect connection to abnormal ports, port scanning, and excessive traffic to/from ports. Overall, this approach is useful when an attack shows statistics significantly different from the normal behaviors. However, it would be useful to be able to detect individual malicious logins even if they don't cause a change in the login statistics.

Ball et al. (R. Ball, G. A. Fink, and C. North, “Home-Centric Visualization of Network Traffic for Security Administration,” ACM workshop on Visualization and Data Mining for Computer Security, pp. 55-64 (ACM, 2004) (incorporated herein by reference)) have implemented a network security visualization tool that allows network administrators to explore communication between internal and external machines. For this, they use two grids of cells each presenting an IP address inside or outside the network. By selecting a cell from internal IP plate (an internal computer), all of the cells in the external IP plate that have communicated with this IP are highlighted (selection of external IPs is possible). This presentation is suitable to detect infected internal machines or external IP addresses attacking the network, but is more limited in detection of CLM attacks.

Nyarok et al. (K. Nyarko, T. Capers, C. Scott, and K. Ladeji-Osias, “Network Intrusion Visualization With NIVA, An Intrusion Detection Visual Analyzer With Haptic Integration,” Haptic Interfaces for Virtual Environment and Teleoperator Systems, pp. 277-284 (IEEE, 2002) (incorporated herein by reference)) have developed visualization techniques including a graph-based visualization that represents a node under attack and the other nodes communicating with it. The main goal of this forensics tool is to enable a better understanding of an attack and the scale of its effects required for post-actions.

Role-Based Access Control (“RBAC”) defines rules for access to network resources based on the role of users. Several mechanisms such as Access Control Lists in Linux and Active Directory in Windows systems (See, e.g., Alistair G Lowe-Norris and Robert Denn, Windows 2000 Active Directory (O'Reilly & Associates, Inc. 2000) (incorporated herein by reference).) allow the network administrators to enforce rules of access. Using the notion of groups of users and objects, network administrators can allow or deny access of a group of users to a collection of resources. This mechanism is useful for stopping an employee from accessing data or resources they should have never access. For resources that a user might need access, the access is granted even if the user needs it rarely. In fact, business continuity is the main reason for granting more access than is required at each particular point in time. As a result, it has been reported that 50-90% of users are over-entitled. (See, e.g., Schneier B., “Real-World Access Control,” https://www.schneier.com/blog/archives/2009/09/real-world acce.html. (2016). [Online; accessed 19 May 2017] (incorporated herein by reference).) Such excessive permissions are one of the reasons an attacker can move almost freely within a network, and why CLM attacks are difficult to detect.

In response to strengthened networks and servers that resist direct external attacks, attackers have shifted to indirect attack methods. In one such method, the attackers compromise a desktop within a network using a phishing attack. Then they use this foothold to compromise other computers or servers that host valuable data they could not access otherwise. This attack method motivated the production of monitoring and detection tools based on malicious traffic within enterprise networks. These tools rely on an enormous amount of data collected from network and host activities using sensors installed on computers and networking devices. Some detection approaches have only focused on infected computers. Yen et al. (Ting-Fang Yen, Alina Oprea, Kaan Onarlioglu, Todd Leetham,William Robertson, Ari Juels, and Engin Kirda, “Beehive: Large-Scale Log Analysis for Detecting Suspicious Activity in Enterprise Networks,” Proceedings of the 29th Annual Computer Security Applications Conference, pp. 199-208 (ACM, 2013) (incorporated herein by reference)) have proposed a system that automatically mines knowledge from the log data produced by a broad range of security products (e.g., anti-virus, firewall) to detect infected workstations. Fawaz et al. (Ahmed Fawaz, Atul Bohara, Carmen Cheh, and William H Sanders, “Lateral Movement Detection Using Distributed Data Fusion,” Reliable Distributed Systems (SRDS), 2016 IEEE 35th Symposium on., IEEE, pp. 21-30 (incorporated herein by reference)) have proposed a framework for fusing data from different sources within a network to detect orchestrated attacks, including lateral movement. Oprea et al. (Alina Oprea, Zhou Li, Ting-Fang Yen, Sang H Chin, and Sumayah Alrwais, “Detection of Early-Stage Enterprise Infection By Mining Large-Scale Log Data,” Dependable Systems and Networks (DSN), 2015 45th Annual IEEE/IFIP International Conference on. IEEE, pp. 45-56 (2015) (incorporated herein by reference)) proposed a belief propagation technique that determines the state of a computer (i.e., benign vs. malicious) given prior knowledge about its past state and interactions with external resources (e.g., external websites). Using this technique, they have been able to discover new malicious entities. These techniques, however, do not utilize information about credential usage, and therefore cannot detect the important class of CLM attacks addressed by the present invention.

Even though attackers use remote exploits and zero-day vulnerabilities, these methods are overrated. (See, e.g., Joyce R., “USENIX Enigma 2016—NSA TAO Chief on Disrupting Nation State Hackers,” https://www.youtube.com/watch?v=bDJb8WOJYdA. (2016). [Online; accessed 15 Feb. 2017] (incorporated herein by reference).) Instead, as previously noted above, attacks based on credential-based lateral movement (CLM), using usernames and passwords to move laterally between computers within a network (Schneier B., “Credential Stealing as an Attack Vector,” https://www.schneier.com/blog/archives/2016/05/credential stea.html. (2016) [Online; accessed 15 Feb. 2017] (incorporated herein by reference).), have prevailed. Some previous works have studied credential-based attacks. Gonalves et al. (Daniel Gonalves, Joao Bota, and Miguel Correia, “Big Data Analytics for Detecting Host Misbehavior in Large Logs,” Trustcom/BigDataSE/ISPA, 2015 IEEE, Vol. 1. IEEE, pp. 238-245 (2015) (incorporated herein by reference)) employed credential usages for detecting misbehaving computers based on an unsupervised clustering approach. They used features such as the number of successful and failed logins, as well as statistics about administrator logins for detection. Unfortunately, however, their approach is not able to detect CLM because it does not exhibit any statistical abnormalities such as frequent logins. (In comparison, example embodiments consistent with the present invention can identify a single login of an attacker because it relies on the structure of logins instead of just the frequency of them.)

Freeman et al., already cited above, have proposed a supervised statistical method for classification of logins in the client-server interactions. They use several features, including IP reputations to classify benign and malicious logins. In comparison, our method is related to logins within an enterprise network. These logins involve a more complex set of interactions between machines beyond a client-server structure in a public network. Our approach is also different from theirs as we do not need labeled data for training our classifier. Instead, we use a semi-supervised anomaly detection approach.

Eberle et al. (William Eberle, Jeffrey Graves, and Lawrence Holder, “Insider Threat Detection Using a Graph-Based Approach,” Journal of Applied Security Research, 6, 1, pp. 32-81 (2010) (incorporated herein by reference)) have proposed a graph-based detection method for identifying anomalous actions concerning the interactions of computers within a network. Their approach computes the changes of a graph of interactions in comparison with a model of interaction they build atop the most frequent subgraphs of the connections. However, it is not able to correctly distinguish benign changes that occur due to network dynamics from malicious ones.

In view of the foregoing, it would be useful to be able to detect malicious logins (such as those used in CLM attacks) within a private network, such as an enterprise network.

### § 3. SUMMARY OF THE INVENTION

Example embodiments consistent with the present invention can classify logins within a private network as benign or malicious by (a) receiving login patterns within a private network, wherein each login pattern includes one or more attributes of each of (i) a user uniquely associated with the login, (ii) a source computer uniquely associated with the login, and (iii) a destination computer uniquely associated with the login, and wherein each login pattern is characterized as one of (A) a normal login pattern, (B) a benign login pattern, or (C) a malicious login pattern; (b) receiving a new login; and (c) classifying the new login as benign or malicious using the login patterns for the private network that were received.

Some such example embodiments further include: tracking logins to the private network, wherein each login includes one or more attributes of each of (i) a user uniquely associated with the login, (ii) a source computer uniquely associated with the login, and (iii) a destination computer uniquely associated with the login; and extracting “normal” login patterns for the private network from the tracked logins. Such extraction may include, for example, (i) enumerating candidate login patterns from each of the tracked logins, (ii) grouping candidate login patterns, (iii) counting occurrences of each candidate login pattern, (iv) determining orientation scores for each candidate login patterns, and (v) for each of the candidate login patterns, selecting the candidate login pattern as a normal login pattern if at least one of its determined orientation scores is above a specified threshold, and otherwise, not selecting the candidate login pattern as a normal login pattern.

Some example embodiments may further: track logins within the private network, wherein each login includes one or more attributes of each of (i) a user uniquely associated with the login, (ii) a source computer uniquely associated with the login, and (iii) a destination computer uniquely associated with the login; render a display providing a visualization of the login patterns based on the tracked logins; and receive a user input, in association with the visualization display rendered, which defines at least one of the login patterns as either (A) benign, or (B) malicious.

### § 4. BRIEF DESCRIPTION OF THE DRAWINGS

FIG. 1 is a simplified schematic diagram illustrating logins within a private network.

FIG. 2 is a diagram illustrating an example system consistent with the present invention.

FIG. 3 is an example method for classifying a new login in a manner consistent with the present invention.

FIG. 4 is an example method for generating login patterns in a manner consistent with the present invention.

FIG. 5 is an example display user interface consistent with the present invention.

FIGS. 6A-6F are example displays illustrating user interface interactions with a user in an example usage scenario.

FIG. 7 is an example method for generating login patterns in a manner consistent with the present invention.

FIGS. 8A-8C illustrate the concept of login pattern “orientations.”

FIG. 9 is a block diagram of an exemplary machine that may perform one or more of the processes described, and/or store information used and/or generated by such processes.

### § 5. DETAILED DESCRIPTION

The present invention may involve novel methods, apparatus, message formats, and/or data structures detecting malicious logins in a private network, such as an enterprise network for example. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

In the following, a “benign” login pattern may be either (a) one consistent with logins that normally occur within the private network, or (b) a login pattern defined as benign (or selected as benign) by a network administrator.

The present inventors observed that an attacker's usage of stolen credentials might differ from the expected login behaviors of a credential in terms of:

Access Characteristic. For example, an attacker may use a stolen credential to log in from a desktop to another desktop, as opposed to a server, a valid but rarely expected login in most enterprise network.

Time. For example, the attacker may be located in a different time-zone and use the credentials when the actual user is not usually active.

Frequency. For example, attackers may connect to destination(s) more often than expected.

Login Result. For example a login failure may happen because the stolen credential is not authorized to login to the destination due to an access rule unknown to the attacker.

Hence, deviations from an expected login (also referred to as a normal or benign login) behavior can signify an attack. While attackers can avoid being detected, by using stolen credentials cautiously (e.g., using the credentials less frequently, at the time that credential is usually active), some suspicious login behaviors are inevitable. This is because (1) an attacker needs to move between computers to access more valuable resources located deeper in the network, and (2) the attacker can only use one of the already compromised computers to move to the new ones. Example embodiments consistent with the present invention use such inevitable login deviations to detect, or at least help detect, subtle lateral movements.

Since attackers often use stolen credentials in different ways each of which might need a dedicated approach for detection, example embodiments consistent with the present invention exploit the inventors' observation that malicious logins typically differ from the expected norm of a login concerning the user, source, or destination of it.

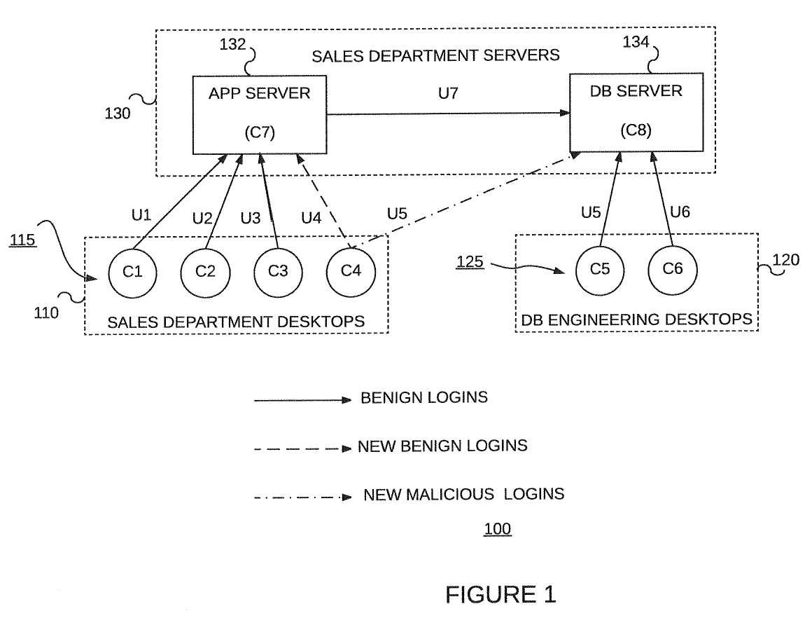

FIG. 1 is a simplified schematic diagram illustrating logins within a private network 100. The private network includes computers 115 of an enterprise's sales department 110, computers 125 of the enterprise's database engineering group, and servers 132/134 of the enterprise's sales department 130. In FIG. 1, solid lines represent logins that are observed in a past time interval. Note that the sales department desktop computers C1-C4 115 logged into the app server C7 132, while the database engineering group desktop computers C5-C6 125 logged into the DB server C8 134. The dashed line is a new login that is benign (as it is consistent with past login patterns), while the dot-dashed line is a new login that is malicious (as it is inconsistent with past login patterns).

As noted above, Credential-based Lateral Movement (CLM) is a network attack method in which an attacker uses a stolen credential to log in to a new computer to compromise it and therefore append it to a chain of hacked computers. Recall that an attack of this type usually starts with a phishing attack that compromises a user's workstation within an enterprise network. Further recall that the end goal of the attacker is to compromise computers that host high-value assets, such as a database or an application server enabling critical operations. In their journey from a workstation to a target server, the attacker continually steals new credentials and uses them to compromise a computer and extend the chain of compromised computers. We can describe a state of an attack using a set CC of compromised computers and a set CU of compromised user accounts (i.e., stolen credentials). In this context, a compromised computer is one that is owned by and located within a private (e.g., enterprise) network, but being exploited by an attacker to run an arbitrary program (e.g., malware). Relying on compromised computers as stepping-stone, the next move of an attacker is to use a stolen credential u (i.e., u∈CU) to login from a compromised source computer s (i.e., s∈CC) to compromise a destination computer d that is not already compromised (i.e., d∉CC). As the attacker uses credentials to log in to computers, some of his login connectivities might be inconsistent with normal network logins concerning user account and computers involved in those logins. Such inconsistencies are inevitable because the attacker can only use computers and user/system accounts that he has already compromised, for their logins to computers that he wants to compromise. Example embodiments consistent with the present invention leverage this observation to detect malicious logins.

§ 5.1 Example Systems(s) for Classifying Logins

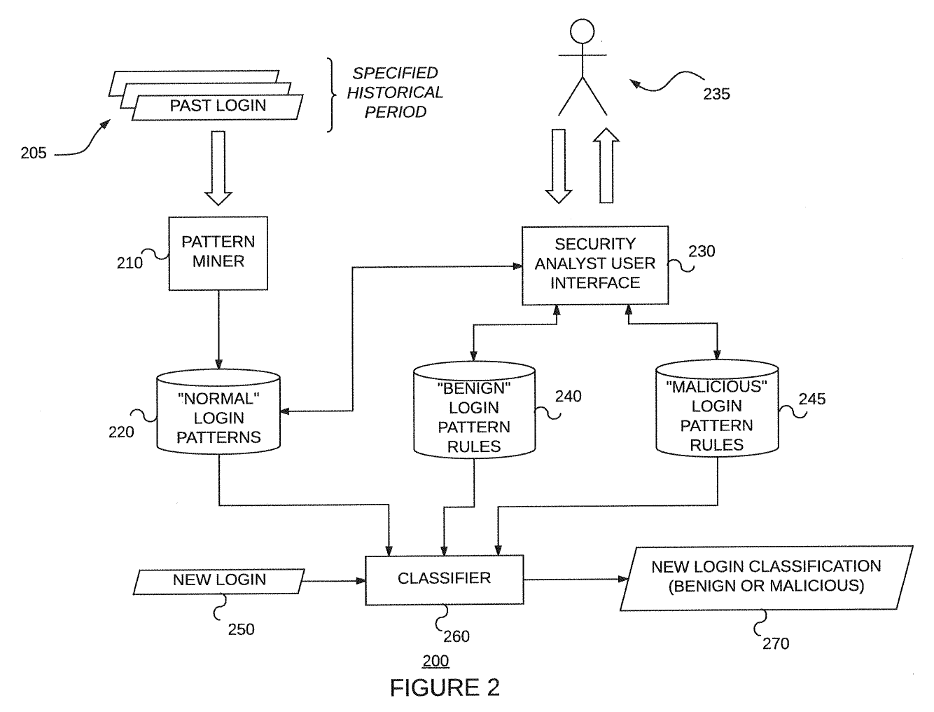

FIG. 2 is a diagram illustrating an example system 200 consistent with the present invention. A classifier 260 may use one or more of “normal” login patterns 220, previously defined “benign” login patterns 240, and previously defined “malicious” login patterns 245 to classify a new login 250 as benign or malicious 270. The “normal” login patterns 220 may be extracted from past logins 205 by a pattern miner 210. The previously defined “benign” login patterns 240 and/or the previously defined “malicious” login patterns 245 may be been defined or selected by a user 235 via a security analyst user interface 230.

It will be apparent that example embodiments consistent with the present invention do not require all of the foregoing components. For example, the classifier 260 may simply use “normal” login patterns 220 generated automatically by the pattern miner 210. As another example, the classifier may simply use login patterns previously defined (e.g., by a user 235 via interface 230) as either benign 240 or malicious 245.

§ 5.2 Example Method(s) for Classifying Logins

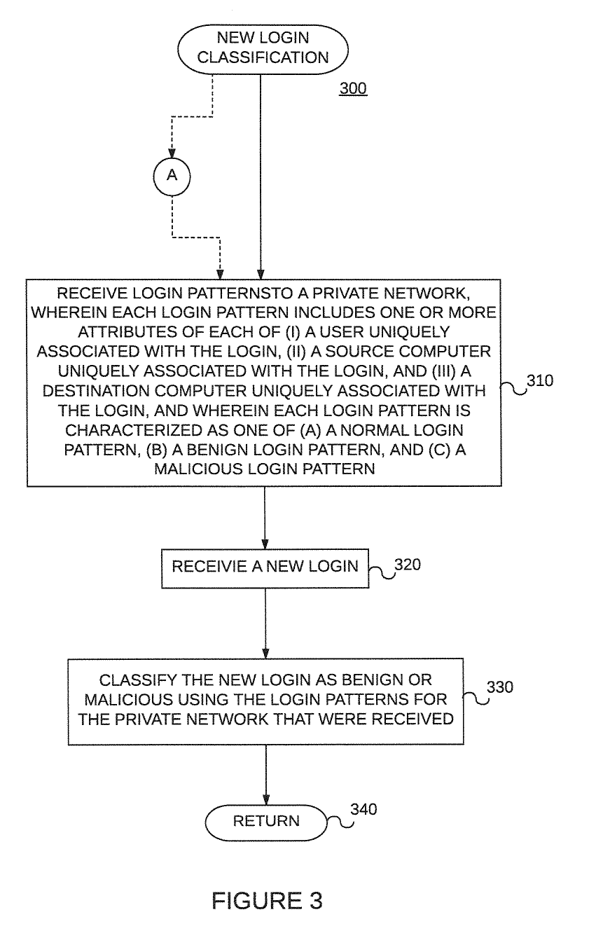

FIG. 3 is a flow diagram of example method 300 for classifying a new login. As shown, the example method 300 receives login patterns within a private network, wherein each login pattern includes one or more attributes of each of (i) a user uniquely associated with the login, (ii) a source computer uniquely associated with the login, and (iii) a destination computer uniquely associated with the login. (Block 310) Each login pattern is characterized as one of (A) a normal login pattern (Recall, e.g., 220 of FIG. 2.), (B) a benign login pattern (Recall, e.g., 240 of FIG. 2.), or (C) a malicious login pattern (Recall, e.g., 245 of FIG. 2.). The example method 300 then receives a new login (Block 320) and classifies the new login as benign or malicious using the login patterns for the private network that were received (Block 330). The method 300 is then left. (Node 340)

The private network may be an enterprise network, in which case the attributes of the user may include at least one of (A) type of user, (B) title of user within the enterprise, (C) department of the user within the enterprise, and (D) an office location of the user within the enterprise. The attributes of the user may include type of user, and wherein the type of user is either (A) end user, or (B) administrative user.

The attributes of the source computer include at least one of (A) server or workstation, and (B) geographic location of the source computer.

The attributes of the destination computer include at least one of (A) server or workstation, (B) geographic location of the destination computer, and (C) application or type of application hosted by the destination computer.

§ 5.3 Example Subprocesses and System Components

Some example embodiments consistent with the present invention may rely on user feedback, via a visualization user interface, to define or select “benign” and/or “malicious” login patterns. (Recall, e.g., 230, 235, 240 and 245 of FIG. 2.) These are described in more detail in section 5.3.1 below. Some example embodiments consistent with the present invention may use automated extraction procedures to determine “normal” login patterns. (Recall 205, 210 and 220 of FIG. 2.) These are described in more detail in section 5.3.2 below.

§ 5.3.1 User Interface for Defining or Selecting “Benign” and/or “Malicious” Login Patterns

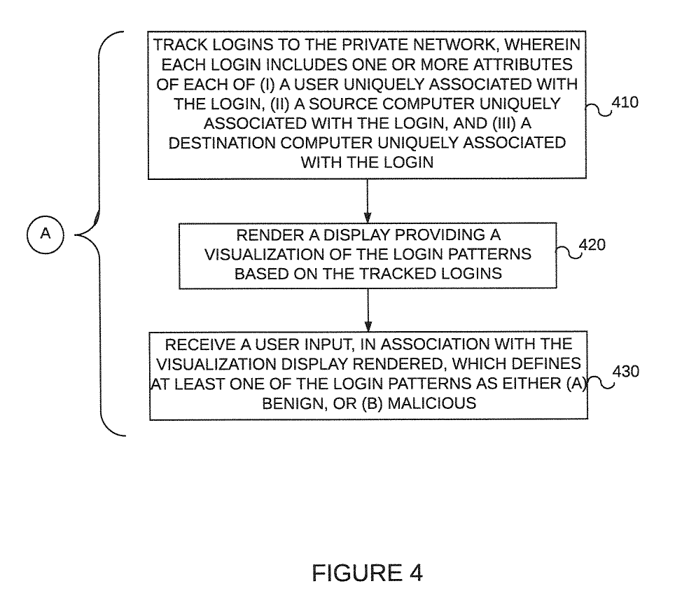

FIG. 4 is a flow diagram of acts that may be used to gather user feedback, via a visualization user interface, to define or select “benign” and/or “malicious” login patterns. As indicated by the node “A”, these acts may be used in conjunction with the method 300 of FIG. 3. Logins within the private network are tracked, wherein each login includes one or more attributes of each of (i) a user uniquely associated with the login, (ii) a source computer uniquely associated with the login, and (iii) a destination computer uniquely associated with the login. (Block 410) A display providing a visualization of the login patterns based on the tracked logins is then rendered. (Block 420) Then, user input, in association with the visualization display rendered, is received. Such user input defines at least one of the login patterns as either (A) benign, or (B) malicious. (Block 430)

As described in the '772 provisional, an example system, called “APT-Hunter,” can be used to help a security analyst or analysts detect malicious login-based lateral movements. That is, APT-Hunter is a visualization tool that helps the security analysts detect malicious login events inside an enterprise network. With this example visualization tool, the graph of logins between computers follows patterns that are understood by security analysts who have designed or operated the systems and network that they are monitoring. This example visualization tool enables security analysts to integrate this knowledge into the detection system in the form of rules that define login patterns. These patterns include both logins that are expected to be seen (benign), and those that are conceptually prohibited (malicious).

§ 5.3.1.1 Design Guidelines Used for APT-Hunter

Design guidelines for a visualization tool, consistent with the present invention, that helps security analysts to detect malicious logins in enterprise networks are now described.

Guideline 1 (G I): Enhance the recognition of login patterns. Tools developed for monitoring login events should ease the recognition of suspicious and benign patterns using appropriate visual representations.

Guideline 2 (G II): Enable expressing and matching login patterns. To decrease the effort required to recognize suspicious and benign login events, the system should allow analysts to express the rules of interest permanently (e.g., login events from a specific source should be recognized as suspicious). So, the next time that the system recognizes such patterns it will automatically label them as suspicious or benign without requiring analysts' interference.

Guideline 3 (G III): Enable selection and filtering of login events. To facilitate the data exploration process for a large number of login events, the system should allow analysts to select (i.e., query) and filter a specific subset of login events based on their desired criteria.

Security Information and Event Management systems (“SIEM”) are widely deployed in enterprise networks and they collect a myriad of relevant login information to aid detection. However, as previously noted, effective detection of malicious logins by such systems alone is difficult for two reasons; namely (1) variability of login events, and (2) lack of an appropriate presentation method. Each is discussed below.

First, regarding variability of login events, network anomaly detection is challenged by variability of network traffic. (See, e.g., R. Sommer and V. Paxson, “Outside the closed world: On using machine learning for network intrusion detection,” IEEE symposium on security and privacy, pp. 305-316 (IEEE, 2010) (incorporated herein by reference).) Similarly, the process of automatically detecting logins abnormalities based on the changes in access characteristics (<User, Source, Destination>) of logins is hindered by variability of login events. For example, a new domain controller in a network is a new destination of logins from hundreds of computers. Without the required background knowledge about this change in the network, these new logins may create an unmanageable number of false alerts. Variability of logins are also related to the role of the users, computers, and business needs of the organization. Integrating the background knowledge about the rules governing the login between computers (which is network-specific) with the detection system makes it useful to keep security analysts in the loop.

Second, regarding a lack of an appropriate presentation method, even if a security analyst is in the loop, the process of discovering login patterns is hindered by a lack of appropriate methods to present the collected login information to the analyst. As previously noted, many existing systems show collected login information using tables where each row shows a user login and each column indicates different characteristics of the login (e.g., username, source and destination of the login, time, result of login). While using tables is a good first step toward visualizing such data, exploration and detection of malicious logins using tables is non-trivial since a combination of different user attributes (e.g., type of user, department, unit, role) and computer attributes (e.g., type of machine, location) need to be considered. As the number of collected data increases, the size of the tables also increases and it becomes more challenging to explore login events using a tabular presentation.

Using a visualization user interface consistent with the present invention, security analysts iteratively discover suspicious and benign login patterns with the help of an interactive node-link visualization tool. To increase the flexibility of the pattern discovery process, example embodiments consistent with the present invention are equipped with a rule-based language that enables analysts to assign the discovered patterns into two classes of suspicious and benign rules. Based on defined patterns, example embodiments consistent with the present invention may then match and tag suspicious and benign patterns in the login events. As a result of this matching, example embodiments consistent with the present invention may generate a list of alerts (i.e., suspicious logins). Analysts can then verify suspicious logins by performing a deeper analysis and positively identify malicious logins.

§ 5.3.1.2 Example Interface Design

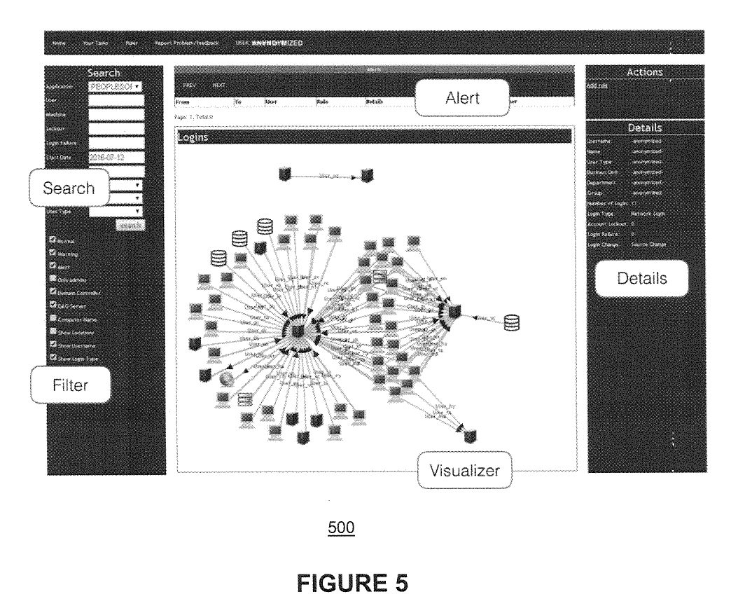

FIG. 5 shows an example user interface 500 of APT-Hunter. It is composed of Search, Filter, Visualizer, Details, and Alert panels. In this section, we described each of these elements and their functionality.

Search Panel:

The example APT-Hunter user interface supports searching login events (helping to satisfy design guideline G III) based on different criteria. The criteria include application (servers hosting the applications in the enterprise network), computer, and user name. More general search can be done based on computers and user type (e.g., domain controller and database server; admin and help-desk users).

Visualizer Panel:

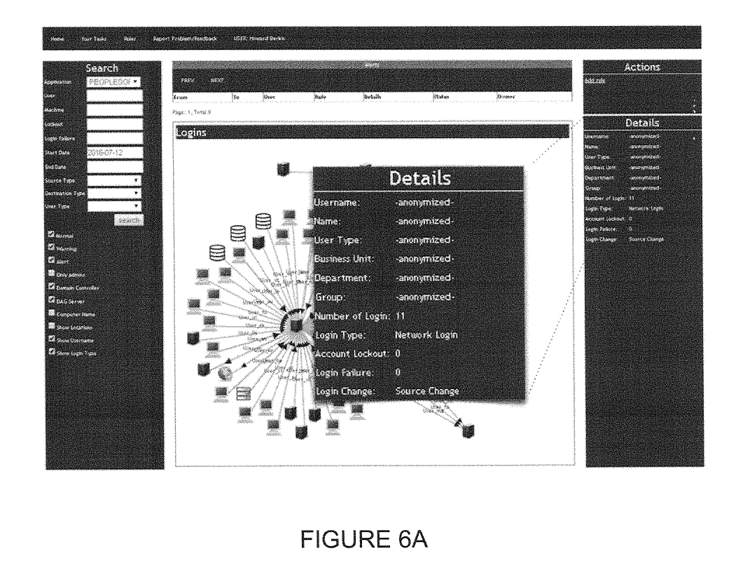

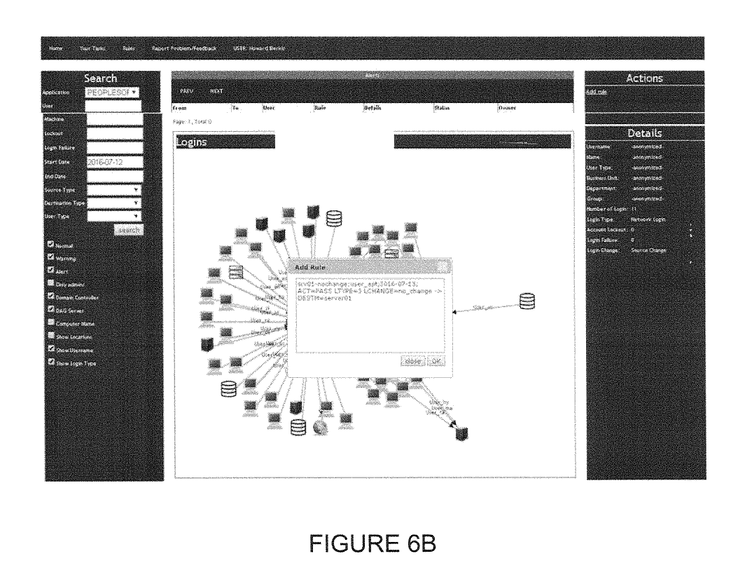

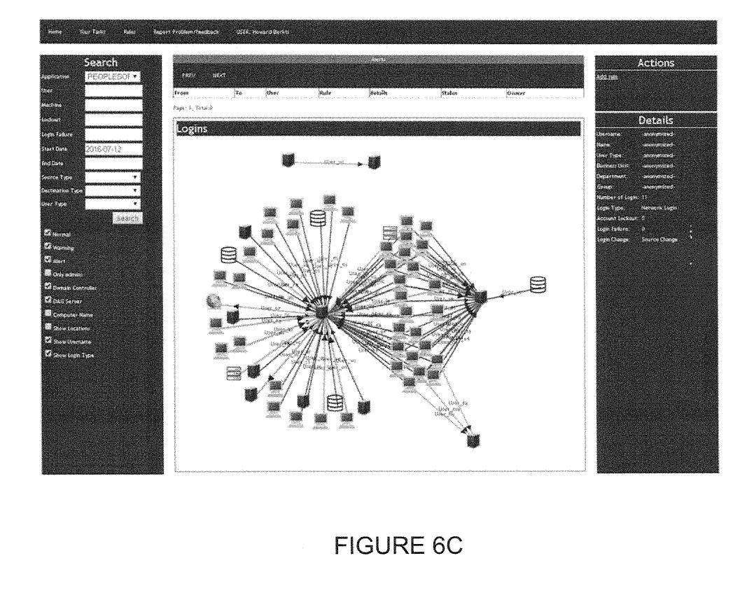

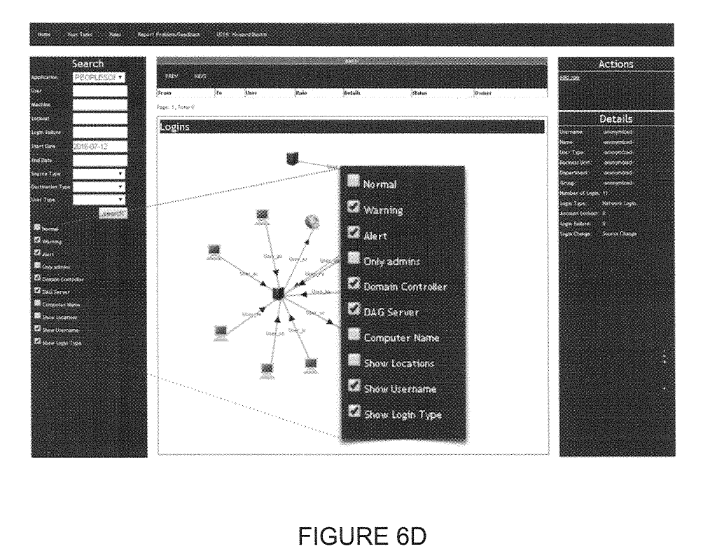

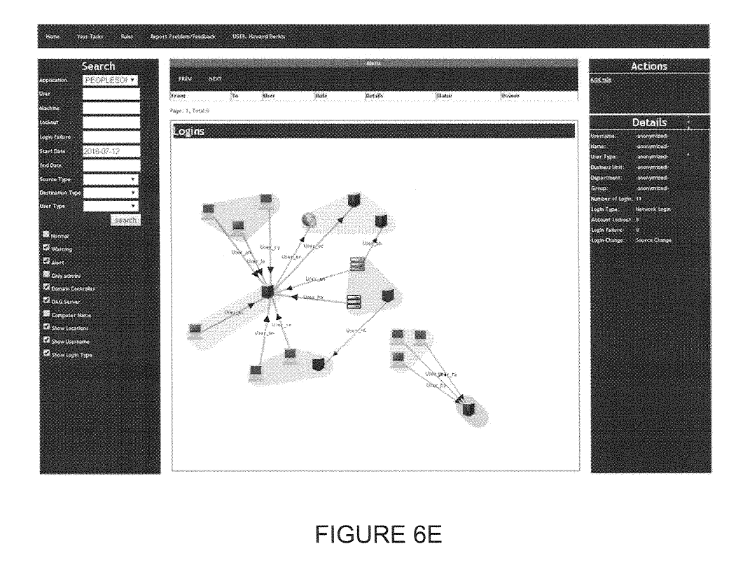

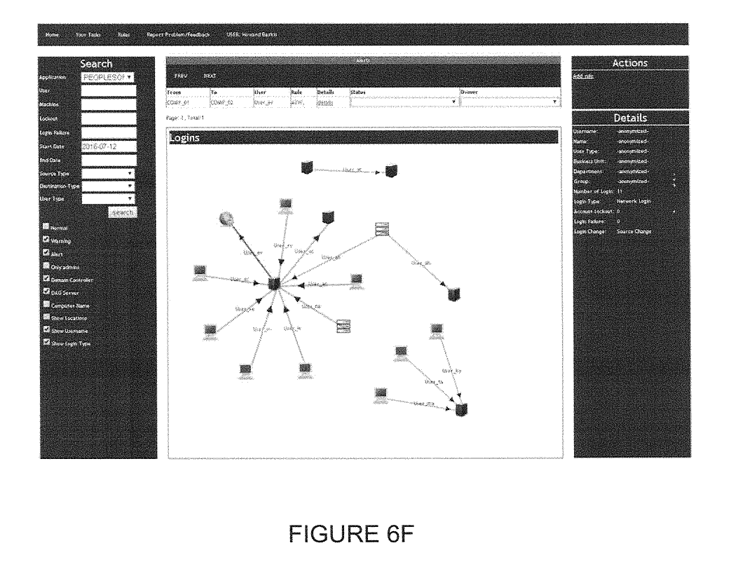

The login data is mainly composed of source and destination computers and users that login from one the other. The example Visualizer panel visualizes this data using an interactive node-link diagram. In this visualization, nodes represent computers, and links show login events from the sources to the destinations. Users can interact with nodes to locate them in the screen or to see more details about them. Some details about computers and logins are encoded using icon and color of the nodes and links. Icons of the nodes show the type and role (e.g., web-server, domain controller) of the computers. The color of the link shows if it is a suspicious login. In addition, geolocation of the nodes are shown by placement of all the computers in the same location next to each other grouped by a colored canvas (See FIG. 6E). The visualizer enables recognition of login patterns and abnormalities (helping to satisfy design guideline G I).

Details Panel:

In the example user interface 500, login events include details of logins that are presented as itemized text. These details include frequency of login, average number of days in a week that a source logins to the destination, number of users that login from a source to a destination, and number of login failures and lock-out of an account. The Details panel provides this information for recognition of patterns (helping to satisfy design guideline G I).

Alert List Panel:

The example APT-Hunter user interface 500 generates alerts by finding login events that match the defined suspicious login patterns. The list of alerts is presented in tabular format. The alerts are sorted in descending order of the number of alerts for the username involved in the alert. Each row of the table shows the source, destination, and user related to the alert. For the sake of verification, a “details” link for each alert links the alert to the visualization of all logins of the user involved in the suspicious login. The status of the investigation can be updated using a drop-down list that appears in front of each login event (helping to satisfy design guideline G II).

§ 5.3.1.3 Example Back-End Engine

This section describes an example back-end engine of the APT-Hunter user interface. The backend has two components: Login Processor & Aggregator, and Pattern Matcher. Although not shown in FIG. 2 above, these components are organized based on a pipeline architecture as shown in the FIG. 3 of the '772 provisional. The input of the back-end includes login information, details about users and computers, and user defined rules (i.e., login pattern). Its output is the list of the login events tagged based on the matched patterns.

§ 5.3.1.3.1 Example Login Processor & Aggregator

The inputs of this component are login events in the network, information about type and role of computers (e.g., workstation, server, database server), their location, and information about type (e.g., admin, service account, normal user), and role (e.g., HR hierarchy) of users. Login events include source, destination, user, type, login result (i.e., success, failure), and date/time. The login information for each day are processed to generate a summary of the number of logins per-day. The login data is also aggregated with computer and user information.

This component compares the login events with history of logins (e.g., logins in the past three month) to spot the login changes. Changes in the login events can be one of the 4 different types: (a) Source Change, (b) Destination Change, (c) User Change (d) and Source&Destination&User Change. For example, a login with “Destination Change” is recognized when a user login to a computer that he has not logged into before (in comparison with the history of logins) from a computer that he has used before. By marking the changes in the login events, this component enables pattern matching based on the changes of the logins. The processed and aggregated login data is used for login visualization as well as pattern matching.

§ 5.3.1.3.2 Example Pattern Matcher

This component loads, parses, and executes the login rules that are defined by operators of the system. The inputs of this system are rules and login events. The output of this component is the set of annotated events for each login which indicates whether the login matches any benign/suspicious login pattern.

The rule may be expressed in a grammar similar to Snort. (See, e.g., the article, M. Roesch et al., “Snort: Lightweight intrusion detection for networks,” LISA, volume 99, pp. 229-238 (1999) (incorporated herein by reference).) For example, the following rule generates an alert for an event of login from a desktop to another desktop by a non-admin user (because this might be a suspicious login in an enterprise network since logins of non-admin users are expected to be from desktops to servers):

(*) RULE_TYPE=ALERT; SRCM_T=DESKTOP USER_T=NORMAL->DESTM_T=DESKTOP; LOGIN-TYPE=NETWORK

§ 5.3.1.4 Example Usage Example

This section illustrates the functionality of the example user interface 500 of FIG. 5 via a usage scenario of real deployment in an enterprise network. FIGS. 6A-6F depict a series of screenshots showing the usage of the APT-Hunter for pattern discovery and malicious login detection. In the screenshot of FIG. 6A, the analyst visits the details of computers and users related to a login. In the screenshot of FIG. 6B, the analyst adds a rule (suspicious or benign) to the system. As depicted in the screenshot of FIG. 6C, by adding a pattern of benign logins, matching logins are identified and shown in the user interface.

As shown in the screenshot of FIG. 6D, analysts can filter logins based on different criteria (e.g., benign) to see a subset of logins of interest. As shown in the screenshot of FIG. 6E, analysts can see data from different views include geolocation. Computers in the same location are shown in one canvas. Finally, as shown in the screenshot of FIG. 6F, by adding a suspicious login pattern, system matches and visualizes the instances of the malicious attack with a different color. Alert(s) also will be listed in Alerts table.

Assume that Walter is a security analyst responsible for detecting malicious logins using APT-Hunter. The user interface 500 of APTHunter that helps Walter to do this task is shown in FIG. 5. Consider the following single iteration of tasks for finding suspicious logins.

Upon loading the latest login data, the system will show a node-link visualization of collected logins. Since the number of logins is very large, Walter decides to start by working on a subset of important logins. That is, he decides to see the login to/from a number of critical servers hosting an important application. He does so by searching the application from a dropdown menu from the search panel of the APT-Hunter. Other criteria for search include name or type of user and computers, location and result of the login, and the date interval. (See, e.g., the Search Panel in FIG. 5.)

The result of Walter's search is shown in the Visualizer panel using a node-link visualization. In this visualization, nodes represent computers, links show login from one computer to another one, and line endings show the direction of the login. (See, e.g., the Visualizer Panel in FIG. 5.)

Further details about the logins are represented by icons, text, or placement of elements. For example, type of computers (e.g., desktop, database, domain controller) is presented using different icons in the graph, names of the computers and users are shown as text next to the nodes and edges of the login graph, and geolocation information about computers is presented by placement of all the computers in the same location next to each other grouped by a colored canvas. It is optional to see some of these layers of details. Moreover, by selecting specific nodes or links in the Visualizer panel, Walter would be able to see their details in the Details panel. (See, e.g., FIG. 6A.) By exploring logins and different layers of details, Walter discovers some benign and suspicious logins:

Discovering a benign login pattern: By exploring logins, Walter notices that a subset of these logins are related to staffs from a specific office that should be able to use the specified application. Since they are using their own computers to connect to these server, and are allowed to use this application as part of their duties, Walter assumes that these logins are harmless. This conclusion is based on his background knowledge about the system and what is presented by APT-Hunter.

Walter decides to define this type of login as a benign patterns. To do this, Walter selects one of these logins by clicking on the link between two nodes. He then clicks on the Add rule option in the Action panel. The application recommends potential rule in text format using a dialog box. (See FIG. 6B.) Walter can edit the rule to adjust the right level of generalization. He is also able to make the rule that defines the pattern stricter by specifying the time (e.g., weekday vs. weekends), maximum allowed login failure or account lockout, and frequency of logins. Rules are composed of pairs of attribute-values with a comparison operator between them. The grammar of rules is similar to Snort and is easy to learn.

As soon as the rule is added to the system, APT-Hunter tags all matching logins of this type as benign. These logins are presented with a different color indicating that they are benign logins. (See, e.g., FIG. 6C.)

While exploring the login events further, Walter filters out benign logins by choosing options from the Filter panel. By doing this, he can stay focused on logins that might be suspicious. (See, e.g., FIG. 6D.) He observes that an admin account has connected to the web-proxy from the server. Based on his knowledge about the logic of the network communication in this enterprise network and role of the servers, he can not find any legitimate reason for the server to login to the web-proxy. He concludes that this login is potentially related to an instance of data exfiltration by an attacker. Therefore, he decides to look further into this incident. He creates a new login pattern to tag the similar suspicious login incidents by using the Add rule from Actions. By defining this rule, the APT-Hunter's rule engine will tag and generate an alert for each login incident matching this pattern. The edges of the node-link graph related to the login will be marked by a red color indicating the suspicious login. (See, e.g., FIG. 6F.) The alerts will also be shown in the Alerts table.

Alerts generated by APT-Hunter signify suspicious logins and may need to be verified further for assurance. The outcome of the verification of an alert may indicate a compromised account (e.g., stolen password), an account abuse (e.g., an admin account used for running a scheduled process instead of using a service account), or a false alarm. For verifying the alerts, Walter utilizes the user interface to study the details of logins and search the login events to/from nodes connected to the potentially infected computer.

§ 5.3.2 Example Automated Pattern Mining

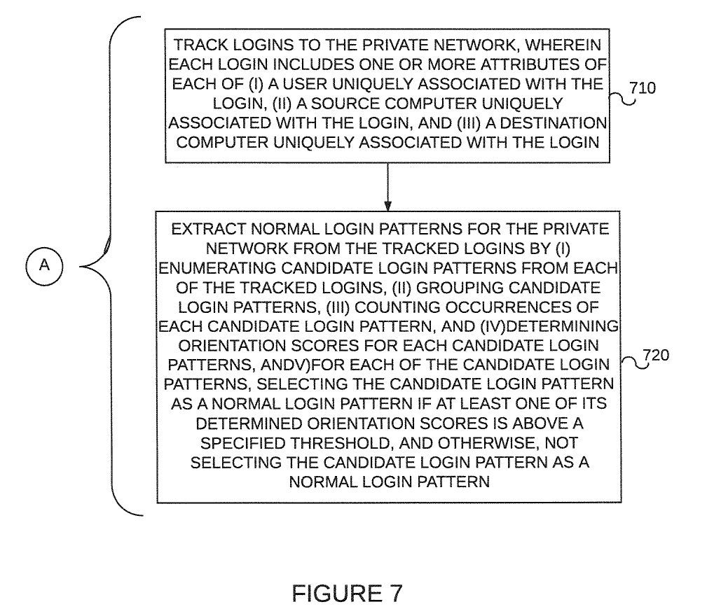

FIG. 7 is a flow diagram of acts that may be used to automatically extract “normal” login patterns from past logins. As indicated by the node “A”, these acts may be used in conjunction with the method 300 of FIG. 3.

As shown in FIG. 7, logins to the private network (wherein each login includes one or more attributes of each of (i) a user uniquely associated with the login, (ii) a source computer uniquely associated with the login, and (iii) a destination computer uniquely associated with the login) are tracked. (Block 710) Then, normal login patterns for the private network are extracted, automatically, from the tracked logins. (Block 720) This automatic extraction may include (i) enumerating candidate login patterns from each of the tracked logins, (ii) grouping candidate login patterns, (iii) counting occurrences of each candidate login pattern, (iv) determining orientation scores for each candidate login patterns, and (v) for each of the candidate login patterns, selecting the candidate login pattern as a normal login pattern if at least one of its determined orientation scores is above a specified threshold, and otherwise, not selecting the candidate login pattern as a normal login pattern.

In some example embodiments, the orientations scores for each candidate login pattern include (1) a user orientation score reflecting a ratio of users that satisfy the user attribute of the login and appear in an occurrence of the candidate login pattern to a total number of users that satisfy the user attribute of the login, (2) a source computer orientation score reflecting a ratio of source computers that satisfy the source computer attribute of the login and appear in an occurrence of the candidate login pattern to a total number of source computers that satisfy the source computer attribute of the login, and (3) a destination computer orientation score reflecting a ratio of destination computers that satisfy the destination computer attribute of the login and appear in an occurrence of the candidate login to a total number of destination computers that satisfy the destination computer attribute of the login. A login is an “occurrence” of a candidate login pattern if and only if (1) the user attribute of the login is a strict subset of the user attributes of the candidate login pattern, (2) the source computer attribute of the login is a strict subject of the source computer attribute of the candidate login pattern, and (3) the destination computer attributed of the login is a strict subset of the destination computer attribute of the candidate login pattern.

In these example embodiments, the detection of malicious logins is anomaly-based and focuses only on identifying abnormal connectivities. Referring to the left side of FIG. 2, an example automated login anomaly detection system may include a pattern miner 210 and a login classifier 260. Examples of each component are described below.

§ 5.3.2.1 Example Pattern Miner and Classifier

This example method of detecting malicious logins relies on their inconsistency with “normal” logins. Therefore, this example method models the normal logins within a private (e.g., enterprise) network. That is, this method specifies how users usually login between computers. To model these logins, we introduce the notion of a “login pattern,” which describes a subset of network logins with regards to their connectivities. For example, it is intuitive to observe, based on the logins of FIG. 1, that logins of Sales from a desktop in that department to the application server is a normal login pattern. We define a login pattern Pas a set of attributes for both users and computers, and show it as a triplet of such attributes [symbol] = [symbol] Û, Ŝ, \hat{D} [symbol] . Examples of such attributes are the type (e.g., primary, admin or service account) and title (e.g., investment banking manager, help desk) for a user, and role (e.g., workstation or server), location, and type of application that a server computer hosts, for computers.

The role of the example pattern miner component 210 is to mine logins and extract login patterns. Inputs of this component are the history of all logins of an interval 205 (for example, spanning a few months in the past) and the attributes of both users and computers during the given time interval. After processing these logins and mining patterns, this component 210 outputs a collection of login patterns as well as confidence scores that indicate their reliability. Structure of logins within an enterprise network are subject to change. Therefore, the pattern miner component 210 should be scheduled to mine and update login patterns periodically. The optimum frequency of updates (and the extent of login data used) depends on the pace of changes in the network login structure.

Another component of this example system is a classifier 260. New logins 250 are one of the inputs to this classifier 260. It also uses normal login patterns 220 extracted by the pattern miner component 210 as another input. (Although not described in detail in this section, the classifier may also use login patterns manually defined (for example, as previously described) as being “benign” or “malicious”. By computing the similarity of the new login with the class of normal logins, this component classifies new logins into one of two classes; benign or malicious.

As introduced above, the pattern miner 210 extracts login patterns each of which specifies a network login substructure. A pattern is composed of attributes of a user, a source computer, and a destination computer. Before describing the algorithm that mines patterns, we first define some terms.

“Login” A login of a user u from computer s to d is uniquely identified and presented by a triplet l=<u, s, d>. For example, in FIG. 1, the network login of the user u₁ from the source computer c₁ to the destination computer c₇ can be represented by a triplet <u₁, c₁, c₇>.

“Login History” A collection of logins from a given time interval in the past composes a login history H. The pattern mining algorithm uses H to mine the login patterns.

“Login Attributes” Each of the three elements of a login has some attributes. Therefore, a login can be represented by a triplet of attributes in form of A=<U, S, D> where U={x|x∈Aᵤ} is the collection of all attributes of the user u, S={y|y∈A_{c}} of the login destination. Each attribute describes one aspect of the login, including the role of user or computer, location, or type of computer. In the example of FIG. 1, the login attributes of login l=<u₁, c₁, c₇> are A=<(primary;Salesstaff); (Desktop,SalesDept); (Server,SalesApp)>.

TABLE 1
Notations and description of symbols.

| Symbol | Description |
|---|---|
| l = <u, s, d> | A login, composed of user, source, and destination. |
| L = <U, S, D> | A login attribute, composed of attributes of each |
| | component. |
| [symbol] = [symbol] Û, Ŝ, \hat{D} [symbol] | A login pattern, composed of some attributes of |
| | each component. |
| <U*, S*, D*> | Power set of attributes. |

“Login Pattern” A login pattern [symbol] = [symbol] Û, Ŝ, \hat{D} [symbol] describes a substructure of network logins. Each element of the pattern is composed of a subset of the attributes of users and computers. In the example of FIG. 1, [symbol] ₁ 1=<(SalesStaff); (Desktop,Sales Dept); (SalesApp)> is one of the patterns.

“Pattern Occurrence” We say that a login l=<u,s, d> with attributes A=<U, S, D> is an occurrence of the pattern [symbol] = [symbol] (Û, Ŝ, \hat{D} [symbol] iff Û ⊂ U, Ŝ ⊂ S, and \hat{D} ⊂ D. We show this by l [symbol] . For example, the login <u₄, c₄, c₇> is an occurrence of the pattern P₁. In comparison, the login <u₇, c₅, c₈> is not an occurrence of it. It should be noted that a login can be an occurrence of several login patterns.

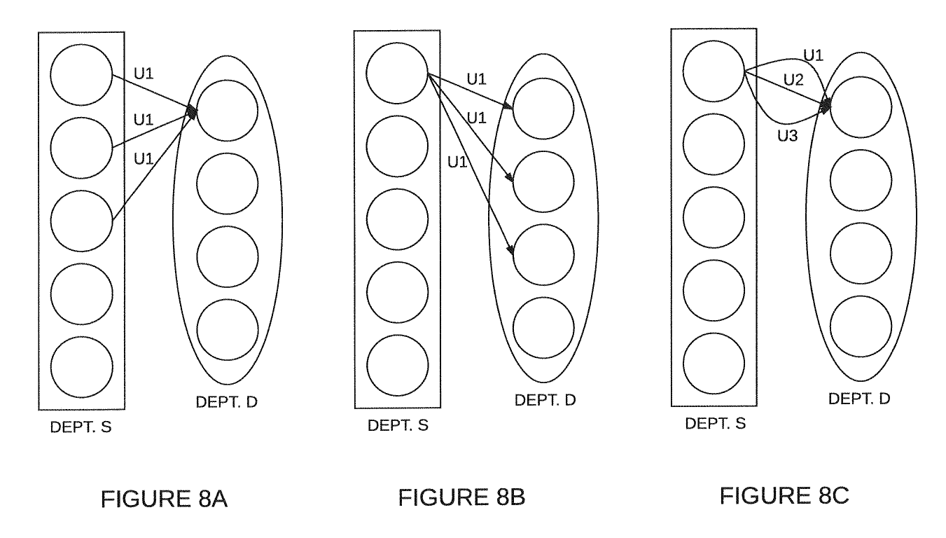

“Pattern Orientation” Depending on the ratio of number of users and computers of a type describing a pattern to all users and computers of that type, a login pattern can be categorized to source-oriented, destination-oriented, and user-oriented. FIGS. 8A-8C show several possible orientations for a pattern. Below, we describe each of these orientations:

“Source-Oriented” A pattern [symbol] = [symbol] Û, Ŝ, \hat{D} [symbol] is sourceoriented if a noticeable fraction of source computers with attributes S have at least one pattern occurrence in login history H. An example of this orientation is the pattern describing logins of all employees of a department to a server hosting an application related to responsibilities of that department.

“Destination-Oriented” A destination-oriented pattern has a noticeable fraction of destination computers with attributes D with at least one pattern occurrence in H. An example of this orientation is pattern of logins of a patch management server that accesses several computers of a given type to push patches of an operating system or application.

“User-Oriented” A user-oriented pattern has a noticeable fraction of users with attributes U with at least one pattern occurrence in H. An example of this orientation is pattern of delegated logins of many users through proxy applications such as mobile gateways or exchange servers.

“Orientation Score” Some example methods consistent with the present invention compute a score for each of the three orientations. An orientation score represents the degree to which a pattern has an orientation. A login might have high scores for more than one orientation. For example, a pattern related to the logins of desktops to domain controllers has a high score for all orientations because all users and computers connect to the domain controllers since they are configured to work in a load-balancing manner. Later in this section, we will describe how our algorithm computes the orientation scores.

TABLE 2
Orientation scores of a pattern with different orientations as shown
in FIGS. 8A-8C. Users are assumed to have same attributes.

| Login Graph | S-score | D-score | U-score |
|---|---|---|---|
| FIG. 8A | 0.6 (=⅗) | 0.25 (=¼) | 0.33 (=⅓) |
| FIG. 8B | 0.2 (=⅕) | 0.75 (=¾) | 0.33 (=⅓) |
| FIG. 8C | 0.2 (=⅕) | 0.25 (=¼) | 1 (= 3/3) |

Example pattern mining methods consistent with the present invention are similar to association rule mining in market-basket analysis algorithms. (See, e.g., the article Jochen Hipp, Ulrich Guntzer, and Gholamreza Nakhaeizadeh, “Algorithms for Association Rule Mining a General Survey And Comparison,” ACM sigkdd explorations newsletter, 2, 1, pp. 58-64 (2000) (incorporated herein by reference).) It employs two steps to mine patterns of network logins. In the first step, it enumerates candidate login patterns from each login in the login history H. In the second step, this algorithm groups login patterns and counts the number of occurrences of each. It also computes their orientation scores. Finally, the algorithm selects patterns with orientation scores above a specified threshold. These selected patterns specify characteristics of the network's login structure and will be used for detecting anomalous logins.

Enumerating Candidate Patterns.

To enumerate candidate login patterns, we first generate three power sets (i.e., the set of all subsets), each based on attributes of elements of login. We denote these power sets by U*, S*, and D*. Then, we create the Cartesian product U*×S*×D* that generates all candidate patterns related to one login. We exclude candidate patterns that are missing all the attributes of any login element. Therefore, the number of possible login patterns generated based on a login is equal to (|U*|−1)×(|S*|−1)×(|D*|−1). For example, for a login of a user (“Sales”,“Staff”) from (“Desktop”,“Sales”) computer to (“SalesDept”,“Server”) (see FIG. 1), the number of candidate patterns is 27 (three non-empty subsets of attributes for each element). The total count of unique candidate patterns based on all logins in H depends on the number of unique values of login attributes as well. Process 1 shows a simplified implementation of this algorithm.

Process 1 This process generates all pattern candidates from a given login. The operator * computes power set of a given set.

1: procedure ENUMERATE_PATTERNS (u, s, d)
2: get <U, S, D >
3: gen-powerset <U*, S*, D*>
4: for Û ⊂ U* do
5: for Ŝ ⊂ S* do
6: for \hat{D} ⊂ D* do
7: emit-candidate ( [symbol] Û, Ŝ, \hat{D} [symbol] )

Computing Orientation Scores. To identify the orientations of a pattern [symbol] = [symbol] Û, Ŝ, \hat{D} [symbol] , we calculate three orientation scores for each pattern, as follows:

S-score. This score represents the source orientation of a pattern [symbol] . We compute the ratio of computers that satisfy the attribute S and appear in an occurrence of the pattern [symbol] in the login history H to the count of all computers that satisfy attribute S.

D-score. This score represents the destination orientation of a pattern P. We compute the ratio of computers that satisfy the attributes D and appear in an occurrence of pattern [symbol] in the login history H to the total number of computers that satisfy attributes D.

U-score. This score represents the degree to which a pattern [symbol] is user oriented. We compute the ratio of users that satisfy the attribute U and appear in an occurrence of the pattern [symbol] in the login history H to the total number of users that satisfy attributes U.

Table 2 shows the three orientation scores of patterns presented in FIGS. 8A-8C.

§ 5.3.2.1.1 Fast Pattern Mining

A major part of the foregoing example pattern mining methods is to extract the candidate login patterns and compute the Cartesian product of the power sets for the attributes of each login. The time complexity of these computations over sets of values are non-polynomial, and therefore are very expensive. Also, the total number of unique login patterns extracted from a real dataset of login attributes can be overwhelming. For example, our process generated 2.3 billion candidate patterns from a dataset of more than 600,000 unique logins where nine attributes described each login. The reason for this number of candidate patterns is that each login attribute has several possible values and therefore there are several possible combinations. For example, in the dataset we studied, the location of computers has 70 possible values, each of which indicates a site of the global financial company where a computer located. Considering this volume of patterns to process, process 1 is difficult to scalable. In this section, we describe techniques to tackle this challenge.

To create a fast and scalable process for generating the candidate login pattern of a big dataset, some example methods use encoding to minimize the memory required to represent the patterns, and parallelization to improve the speed of execution by a divide and conquer approach.

To reduce the memory required to store the Cartesian product of power set of attributes, a binary encoding of the attributes of users and computers may be used. The proposed encoding assigns an integer code to each value and generates a binary mask for each different combination of these attributes. Using this method, we present a login entry using the attribute codes. This encoding takes considerably less space than storing string values. More importantly, the login patterns only include attributes that describe a pattern, and the binary mask identifies which code belongs to which attribute. This compresses the space required to store each pattern.

After reading logins and encoding their attributes, the process for generating patterns creates required masks. The number of these masks is equal to 2^{|U|+|S|+|D|}. For example, if total number of attributes of login elements is nine, then 512 mask values, ranging from 0 to 511, will be generated. Our parallelization method splits these masks into several clusters, each assigned to a CPU core for processing. Collectively, these parallel processes generate all pattern candidates and output them into file storage. Spark from Apache may be used for parallelization and Python generators may be used to improve the speed of the pattern generation algorithm.

As an example, for a login Lᵢ=<Uᵢ=(User1, DPT1, GB), Sᵢ=(C1, BLD1, LN), Dᵢ=(C2, BLD2, NY)>, the example process first encodes the string values, say User₁ to 1 (User₁->1) and DTP₁ to 3 (DTP₁->3), etc. After that, the pattern generator creates the power set of the encoded login attributes. For example, for storing<({ }, { }, 2), ({ }, { }, 2), ({ }, { }, 1))> pattern, binary mask 73 (binary 001001001) will be used. Using this encoding, the compressed format of the pattern which is 73:2;2;1 will be stored. This compacted presentation reduces the space required to store generated patterns, dramatically.

For parallelization, the example process runs the pattern processing in a separate cluster for each range of mask values. This parallelization accelerates the pattern mining algorithm to extract patterns within minutes for a big dataset of logins.

§ 5.3.2.1.2 Example Classification

An example classifier consistent with the present invention is a hybrid of two components and evaluates each login independently. The first component uses a exact matching approach and the second one uses pattern matching for classification.

The exact matching classifies a login l=<u, s, d> as benign if there is a login l′=<u′, s′, d′> in the login history H, where u=u′, s=s′, and d=d′. Otherwise, it may classify the login as malicious (or undetermined for further processing). It is possible for an attacker to bypass this classifier by poisoning the login history used for classification. To reduce this possibility, infrequent logins (e.g., less than a specified number, and/or less than a specified percentage of days) may be excluded from the login history. In one example implementation, to be included the login history, a login must occur a sufficient number of times (e.g., minimum 10% of days) during the time interval that the system collects logins. Therefore, an attacker will not be able to contaminate the login history H without many logins that increase the risk of detection. The exact match may also be used to check the new login pattern against those login patterns manually defined as benign or malicious. (Recall, e.g., 240 and 245 of FIG. 2.)

An example pattern matching classifier first generates all possible combination of attributes related to a login L with attributes A=<U, S, D> using the same approach used for enumerating candidate network login patterns. The classifier classifies the login as benign if at least one of the combinations of login attributes matches a pattern of the set of network login patterns that describe the network structure. In other words, login l=<u, s, d> will be classified as benign if it is an occurrence of one of the patterns describing the network login structure. For example, the login <u₄, c₄, c₇> in FIG. 1 is an occurrence of the pattern [symbol] ₁ and therefore will be classified as a benign login. In contrast, the login <u₇, c₅, c₈> is not an occurrence of any of the patterns and consequently will be classified as malicious. The advantage of pattern matching over exact matching is that it is flexible concerning legitimate changes of network logins. In fact, many new logins do not exactly match a previous benign login but match normal login patterns.

In addition to pattern matching, an example process consistent with the present invention may compute a confidence score for each benign login that does not exactly match any past benign login but matches a normal login pattern. The confidence score is computed with respect to the difference(s) with all other occurrences of that pattern. For example, a new login might connect to an instance of a type of destination computer type D that none of the other logins matching a pattern connect to it. In this case, the example process uses the destination orientation of the pattern as the confidence of matching a login with normal logins. Other orientation scores will be used accordingly. This example process may use the minimum orientation score of a pattern if all three elements of a login are different from past logins matching a normal login pattern.

§ 5.4 Example Apparatus

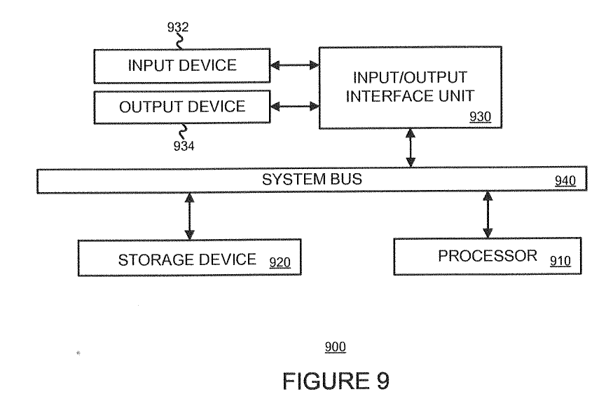

Embodiments consistent with the present invention may be implemented on an example system 900 as illustrated on FIG. 9. FIG. 9 is a block diagram of an exemplary machine 900 that may perform one or more of the processes described, and/or store information used and/or generated by such processes. The exemplary machine 900 includes one or more processors 910, one or more input/output interface units 930, one or more storage devices 920, and one or more system buses and/or networks 940 for facilitating the communication of information among the coupled elements. One or more input devices 932 and one or more output devices 934 may be coupled with the one or more input/output interfaces 930. The one or more processors 910 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 920 and/or may be received from an external source via one or more input interface units 930. The machine executable instructions may be stored as various software modules, each module performing one or more operations. Functional software modules are examples of components of the invention.

In some embodiments consistent with the present invention, the processors 910 may be one or more microprocessors and/or ASICs. The bus 940 may include a system bus. The storage devices 920 may include system memory, such as read only memory (ROM) and/or random access memory (RAM). The storage devices 920 may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or solid-state non-volatile storage.

Some example embodiments consistent with the present invention may also be provided as a machine-readable medium for storing the machine-executable instructions. The machine-readable medium may be non-transitory and may include, but is not limited to, flash memory, optical disks, CD-ROMs, DVD ROMs, RAMs, EPROMs, EEPROMs, magnetic or optical cards or any other type of machine-readable media suitable for storing electronic instructions. For example, example embodiments consistent with the present invention may be downloaded as a computer program which may be transferred from a remote computer (e.g., a server) to a requesting computer (e.g., a client) by way of a communication link (e.g., a modem or network connection) and stored on a non-transitory storage medium. The machine-readable medium may also be referred to as a processor-readable medium.

Example embodiments consistent with the present invention might be implemented in hardware, such as one or more field programmable gate arrays (“FPGA” s), one or more integrated circuits such as ASICs, one or more network processors, etc. Alternatively, or in addition, embodiments consistent with the present invention might be implemented as stored program instructions executed by a processor. Such hardware and/or software might be provided in a laptop computer, desktop computer, a server, a tablet computer, a mobile phone, or any device that has computing capabilities and that can be connected to the private (e.g., enterprise) network.

For example, the components of the system 200 of FIG. 2 (and any components of any example embodiment described in this application) may be implemented as circuitry, such as integrated circuits, application specific circuits (“ASICs”), field programmable logic arrays (“FPLAs”), etc., and/or software (e.g., downloaded or stored on a non-transitory storage medium) implemented on one or more processors, such as one or more microprocessors.

### § 5.5 CONCLUSIONS

Example embodiments consistent with the present invention exploit the inventors' observation that an attackers' pattern of access characteristics of the stolen credentials in the form of <User, Source, Destination> deviates from benign patterns and can be used to detect malicious logins. In some example embodiments, a visualization tool is provided that helps security analysts to explore login data for discovering patterns and detecting malicious logins. Example embodiments consistent with the present invention facilitate pattern discovery and detection and represents a more complex graph of nodes and information encoding. In comparison with known visualization tools, an example visualization tool consistent with the present invention uses login event data for detecting lateral movement.

In some example embodiments, a network login structure is modeled by automatically extracting a collection of login patterns by using a variation of the market-basket algorithm. An anomaly detection approach is then used to detect malicious logins that are inconsistent with the enterprise network's login structure.

Such example embodiments exploit the fact that login connectivities of users within an enterprise are structured and mostly predictable. For example, staff of the human resource department connect to a server hosting an HR application, but employees of the accounting department connect to a server hosting an accounting application. Second, CLMs often involve connections between computers, that are not consistent with the login structure of an enterprise network. For example, an attacker might use a stolen credential to log in from a computer in the HR department to a computer in the accounting department, which is not a typical destination for computers of the HR department. These inconsistencies are inevitable as the attacker can only use stolen credentials he has and computers that he has already compromised to move forward. The difficulty in detecting such unusual movements is arriving at a characterization of normal login patterns in a complex enterprise system, and detecting abnormal logins without incurring high false positives that are inevitable due to the base rate fallacy. Example embodiments consistent with the present invention may use the concept of Network Login Structure that specifies normal logins within a given network. A network login structure may be modeled by automatically extracting a collection of login patterns. These patterns describe how groups of users typically log in between a group of computers. An anomaly detection approach to detect malicious logins that are inconsistent with the login structure of an enterprise network.

Thus, example embodiments consistent with the present invention should provide better ways to detect CLM attacks.

What is claimed is:

1. A computer-implemented method comprising:
a) receiving login patterns within a private network, wherein each login pattern includes one or more attributes of each of (i) a user uniquely associated with the login, (ii) a source computer uniquely associated with the login, and (iii) a destination computer uniquely associated with the login, and wherein each login pattern is characterized as one of (A) a normal login pattern, (B) a benign login pattern, or (C) a malicious login pattern;
b) receiving a new login; and
c) classifying the new login as benign or malicious using the login patterns for the private network that were received.

2. The computer-implemented method of claim 1 wherein the private network is an enterprise network, and wherein the attributes of the user include at least one of (A) type of user, (B) title of user within the enterprise, (C) department of the user within the enterprise, and (D) an office location of the user within the enterprise.

3. The computer-implemented method of claim 2 wherein the attributes of the user include type of user, and wherein the type of user is either (A) end user, or (B) administrative user.

4. The computer-implemented method of claim 1 wherein the attributes of the source computer include at least one of (A) server or workstation, and (B) geographic location of the source computer.

5. The computer-implemented method of claim 1 wherein the attributes of the destination computer include at least one of (A) server or workstation, (B) geographic location of the destination computer, and (C) application or type of application hosted by the destination computer.

6. The computer-implemented method of claim 1 further comprising:
tracking logins to the private network, wherein each login includes one or more attributes of each of (i) a user uniquely associated with the login, (ii) a source computer uniquely associated with the login, and (iii) a destination computer uniquely associated with the login; and
extracting normal login patterns for the private network from the tracked logins by
i) enumerating candidate login patterns from each of the tracked logins,
ii) grouping candidate login patterns,
iii) counting occurrences of each candidate login pattern,
iv) determining orientation scores for each candidate login patterns, and
v) for each of the candidate login patterns, selecting the candidate login pattern as a normal login pattern if at least one of its determined orientation scores is above a specified threshold, and otherwise, not selecting the candidate login pattern as a normal login pattern.

7. The computer-implemented method of claim 6 wherein the orientations scores for each candidate login pattern include (1) a user orientation score reflecting a ratio of users that satisfy the user attribute of the login and appear in an occurrence of the candidate login pattern to a total number of users that satisfy the user attribute of the login, (2) a source computer orientation score reflecting a ratio of source computers that satisfy the source computer attribute of the login and appear in an occurrence of the candidate login pattern to a total number of source computers that satisfy the source computer attribute of the login, and (3) a destination computer orientation score reflecting a ratio of destination computers that satisfy the destination computer attribute of the login and appear in an occurrence of the candidate login to a total number of destination computers that satisfy the destination computer attribute of the login, and
wherein a login is an “occurrence” of a candidate login pattern if and only if (1) the user attribute of the login is a strict subset of the user attributes of the candidate login pattern, (2) the source computer attribute of the login is a strict subject of the source computer attribute of the candidate login pattern, and (3) the destination computer attributed of the login is a strict subset of the destination computer attribute of the candidate login pattern.

8. The computer-implemented method of claim 1 further comprising:
tracking logins within the private network, wherein each login includes one or more attributes of each of (i) a user uniquely associated with the login, (ii) a source computer uniquely associated with the login, and (iii) a destination computer uniquely associated with the login;
rendering a display providing a visualization of the login patterns based on the tracked logins; and
receiving a user input, in association with the visualization display rendered, which defines at least one of the login patterns as either (A) benign, or (B) malicious.

9. The computer-implemented method of claim 1 wherein classifying the new login as benign or malicious includes classifying the new login as benign if it matches either a normal login pattern exactly or a benign login pattern exactly.

10. The computer-implemented method of claim 1 wherein classifying the new login as benign or malicious includes classifying the new login as malicious if it matches a malicious login pattern exactly.

11. The computer-implemented method of claim 1 wherein classifying the new login as benign or malicious includes
i) generating all possible combinations of attributes related to the new login, and
ii) classifying the new login as benign if at least one of the combinations matches one of the normal login patterns or one of the benign login patterns, and otherwise classifying the new login as potentially malicious.

12. The computer-implemented method of claim 11 wherein, responsive to a classifying the new login as benign, determining a confidence score of the classification of the new login.

13. Apparatus comprising:
a) an input adapted to
(1) receive login patterns within a private network, wherein each login pattern includes one or more attributes of each of (i) a user uniquely associated with the login, (ii) a source computer uniquely associated with the login, and (iii) a destination computer uniquely associated with the login, and wherein each login pattern is characterized as one of (A) a normal login pattern, (B) a benign login pattern, or (C) a malicious login pattern, and
(2) receive a new login; and
b) a classifier adapted to classify the new login as benign or malicious using the login patterns for the private network that were received.

14. The apparatus of claim 13 wherein the private network is an enterprise network, and wherein the attributes of the user include at least one of (A) type of user, (B) title of user within the enterprise, (C) department of the user within the enterprise, and (D) an office location of the user within the enterprise.

15. The apparatus of claim 13 wherein the attributes of the source computer include at least one of (A) server or workstation, and (B) geographic location of the source computer, and
wherein the attributes of the destination computer include at least one of (A) server or workstation, (B) geographic location of the destination computer, and (C) application or type of application hosted by the destination computer.

16. The apparatus of claim 13 further comprising:
a login processor adapted to track logins to the private network, wherein each login includes one or more attributes of each of (i) a user uniquely associated with the login, (ii) a source computer uniquely associated with the login, and (iii) a destination computer uniquely associated with the login; and
a pattern miner adapted to extract normal login patterns for the private network from the tracked logins by
i) enumerating candidate login patterns from each of the tracked logins,
ii) grouping candidate login patterns,
iii) counting occurrences of each candidate login pattern,
iv) determining orientation scores for each candidate login patterns, and
v) for each of the candidate login patterns, selecting the candidate login pattern as a normal login pattern if at least one of its determined orientation scores is above a specified threshold, and otherwise, not selecting the candidate login pattern as a normal login pattern.

17. The apparatus of claim 16 wherein the orientations scores for each candidate login pattern include (1) a user orientation score reflecting a ratio of users that satisfy the user attribute of the login and appear in an occurrence of the candidate login pattern to a total number of users that satisfy the user attribute of the login, (2) a source computer orientation score reflecting a ratio of source computers that satisfy the source computer attribute of the login and appear in an occurrence of the candidate login pattern to a total number of source computers that satisfy the source computer attribute of the login, and (3) a destination computer orientation score reflecting a ratio of destination computers that satisfy the destination computer attribute of the login and appear in an occurrence of the candidate login to a total number of destination computers that satisfy the destination computer attribute of the login, and
wherein a login is an “occurrence” of a candidate login pattern if and only if (1) the user attribute of the login is a strict subset of the user attributes of the candidate login pattern, (2) the source computer attribute of the login is a strict subject of the source computer attribute of the candidate login pattern, and (3) the destination computer attributed of the login is a strict subset of the destination computer attribute of the candidate login pattern.

18. The apparatus of claim 13 further comprising:
a login processor adapted to track logins within the private network, wherein each login includes one or more attributes of each of (i) a user uniquely associated with the login, (ii) a source computer uniquely associated with the login, and (iii) a destination computer uniquely associated with the login;
a visualization user interface adapted to
(1) render a display providing a visualization of the login patterns based on the tracked logins, and
(2) receive a user input, in association with the visualization display rendered, which defines at least one of the login patterns as either (A) benign, or (B) malicious.

19. A non-transitory computer-readable medium storing processor-executable instructions which, when executed by one or more processors, cause the one or more processors to perform a method comprising:
a) receiving login patterns within a private network, wherein each login pattern includes one or more attributes of each of (i) a user uniquely associated with the login, (ii) a source computer uniquely associated with the login, and (iii) a destination computer uniquely associated with the login, and wherein each login pattern is characterized as one of (A) a normal login pattern, (B) a benign login pattern, or (C) a malicious login pattern;
b) receiving a new login; and
c) classifying the new login as benign or malicious using the login patterns for the private network that were received.

20. The non-transitory computer-readable medium of 19 wherein the private network is an enterprise network, and wherein the attributes of the user include at least one of (A) type of user, (B) title of user within the enterprise, (C) department of the user within the enterprise, and (D) an office location of the user within the enterprise,
wherein the attributes of the source computer include at least one of (A) server or workstation, and (B) geographic location of the source computer, and
wherein the attributes of the destination computer include at least one of (A) server or workstation, (B) geographic location of the destination computer, and (C) application or type of application hosted by the destination computer.
